(19) United States
(12) Patent Application Publication
(10) Pub. No.: US 2008/0062944 A1
(43) Pub. Date: Mar. 13, 2008

(54) Apparatus and Method For Automatic Repeat Request Signalling With Reduced Retransmission Indications in a Wireless VoIP Communication System

(75) Inventors: Jack A. Smith, Valley View, TX (US); Hao Bi, Lake Zurich, IL (US); Sean M. McBeath, Keller, TX (US); James M. O'Connor, Dallas, TX (US); Danny T. Pinckley, Arlington, TX (US); John D. Reed, Arlington, TX (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Libertyville, IL (US)

(21) Appl. No.: 11/530,352

(22) Filed: Sep. 8, 2006

(51) Int. Cl. H04B 7/216

(52) U.S. Cl. 370/342

(57) ABSTRACT

A base station (103) assigns a set of mobile stations (101) to a group wherein the group will share a set of radio resources. A shared control channel information element (501) is sent to the group of mobile stations (101) and provides a bitmap having fields for a control header (502), utilized resources (510), and first HARQ transmission assignments (530). HARQ subgroups may be defined to associate subgroups of mobile stations with specific HARQ transmission opportunities on the super-frame. The mobile stations (101) are assigned resources in a persistent manner in each long frame of a super-frame for which a first HARQ transmission opportunity is defined.

### CROSS-REFERENCE TO RELATED APPLICATIONS

The present disclosure is related to copending U.S. patent application Ser. No. 11/460,908 “APPARATUS AND METHOD FOR HANDLING CONTROL CHANNEL RECEPTION/DECODING FAILURE IN A WIRELESS VOIP COMMUNICATION SYSTEM,” and U.S. patent application Ser. No. 11/464,179 “APPARATUS AND METHOD FOR AUTOMATIC REPEAT REQUEST WITH REDUCED RESOURCE ALLOCATION OVERHEAD IN A WIRELESS VOIP COMMUNICATION SYSTEM,” both of which are assigned to the same assignee as the present application, and both of which are hereby incorporated by reference herein.

### FIELD OF THE DISCLOSURE

The present disclosure relates generally to Voice-over-Internet-Protocol (VoIP) wireless communication networks and more particularly to such networks utilizing hybrid automatic repeat request (HARQ) and methods and apparatuses with reduced signaling overhead in VoIP wireless communications systems utilizing HARQ mechanisms.

### BACKGROUND

Wireless communications systems, for example packet based communications systems, may provide voice telephony using the Voice-over-Internet-Protocol (VoIP). Any historical demarcation between “data” and “voice” has become blurred in packet based communications systems such that the term “data” usually signifies payload information for any service, whether voice, or data such as may be provided by downloading from the Internet.

Differences remain however, in that voice will generally employ smaller packet sizes, for example due to delay sensitivity, than would traditional so-called data. For, example a non-voice data packet may be larger than a kilo-byte while a voice packet may be only approximately 15 to 50 bytes depending upon the vocoder rate employed.

Because of the smaller packet sizes utilized by voice sessions, a greatly increased number of voice users may be served thereby placing a burden on the control mechanisms and resources of the communications system.

Systems that employ Hybrid Automatic Repeat Request (HARQ) may make use of persistent channels for retransmissions. Persistent channels eliminate the need for the mobile station to decode control channel information for each HARQ retransmission, thereby reducing control channel overhead. However, to make efficient use of the resources of the communication systems, it is necessary to reassign the persistent channel for one mobile station, once the packet is acknowledged, which requires additional overhead.

Thus, there is a need for providing mobile stations with resources for HARQ retransmissions with persistent assignments but without significantly increasing the overhead of the communication system.

### BRIEF DESCRIPTION OF THE DRAWINGS

FIG. 1 is a block diagram of a wireless communication network.

FIG. 2 is block diagram of a sequence of super frames each comprising a several frames.

FIG. 3 is diagram showing a sequence of long frames each comprising one or more frames.

FIG. 4 is logical diagram representation of a set of shared resources.

FIGS. 5a, 5b, 5c and 5d are diagrams of bitmaps sent in a shared control channel for resource assignment purposes.

FIG. 6 illustrates the association of a sequence of HARQ transmission opportunities with long frame numbers for different subgroups in accordance with various embodiments.

FIG. 7 is a diagram of an exemplary resource allocation and ordering pattern in accordance with various embodiments.

FIG. 8 is a diagram showing the exemplary resource allocation and ordering pattern of FIG. 7 at a subsequent long frame in accordance with various embodiments.

FIG. 9 is a diagram of an exemplary resource allocation and ordering pattern in accordance with various embodiments.

FIG. 10 is a block diagram of subgroup assignments in a sectorized base station coverage area.

FIG. 11 is a block diagram of a wireless communication network in which a mobile station sends a request message in accordance with various embodiments.

FIG. 12 is a diagram of an exemplary resource allocation and ordering pattern in accordance with various embodiments.

FIG. 13 is a diagram showing the exemplary request message in accordance with various embodiments.

FIG. 14 is a block diagram of a mobile station and base station architecture in accordance with various embodiments.

FIG. 15 is a block diagram of a mobile station in accordance with various embodiments.

FIG. 16 is a flow chart showing operation of a base station in accordance with various embodiments.

FIG. 17 is a flow chart showing operation of a mobile station in accordance with various embodiments.

FIG. 18 is a flow chart showing operation of a mobile station in accordance with an embodiment.

### DETAILED DESCRIPTION

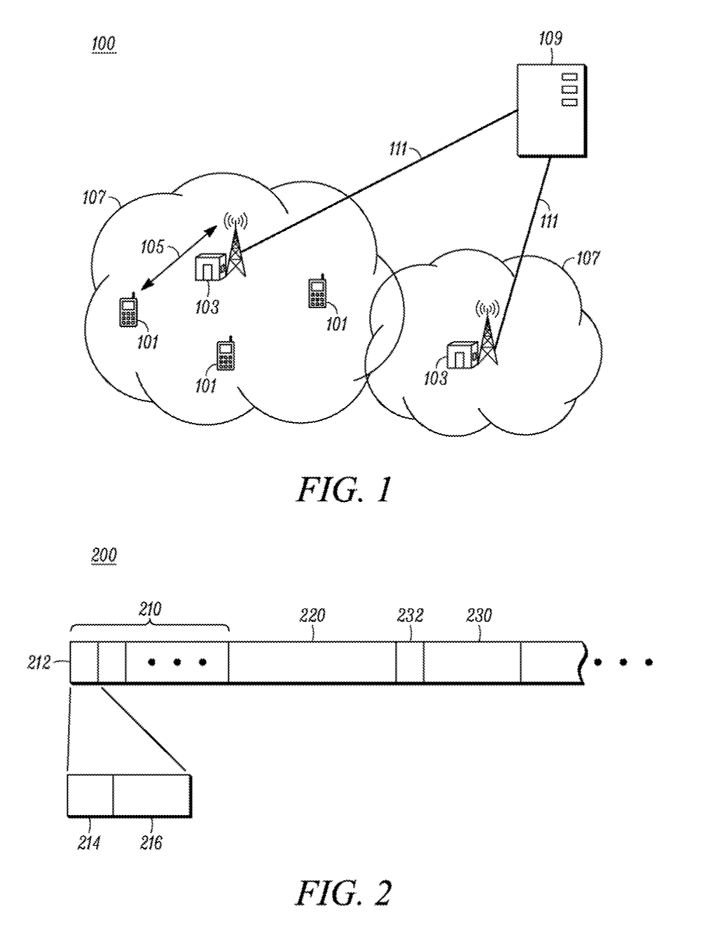

Turning now to the drawings wherein like numerals represent like components, FIG. 1 illustrates a communications network 100, with various base stations 103, each base station 103 having a corresponding coverage area 107. In general, base station coverage areas may overlap and, in general, form an overall network coverage area. The base stations may be referred to by other names such as base transceiver station (BASE STATION), “Node B”, and access node (AN), depending on the technology. A network coverage area may comprise a number of base station coverage areas 107, which may form a contiguous radio coverage area. However, it is not required to have contiguous radio coverage and therefore a network coverage area may alternatively be distributed.

Furthermore, each coverage area may have a number of mobile stations 101. Mobile stations may also be referred to as access terminals (ATs), user equipment (UEs), or other terminology depending on the technology. A number of bases stations 103 will be connected to a base station controller 109 via backhaul connections 111. The base station controller 109 and base stations form a Radio Access Network (RAN). The overall network may comprise any number of base station controllers, each controlling a number of base stations. Note that the base station controller 109 may alternatively be implemented as a distributed function among the base stations 103. Regardless of specific implementations, the base station controller 109 comprises various modules for packetized communications such as a packet scheduler, packet segmentation and reassembly, etc., and modules for assigning appropriate radio resources to the various mobile stations 101.

The base stations 103 may communicate with the mobile stations 101 via any number of standard air interfaces and using any number of modulation and coding schemes. For example, Universal Mobile Telecommunications System (UMTS), Evolved UMTS (E-UMTS) Terrestrial Radio Access (E-UTRA) or CDMA2000 may be employed. Further, E-UMTS may employ Orthogonal Frequency Division Multiplexing (OFDM) and CDMA2000 may employ orthogonal spreading codes such as the Walsh codes. Semi-orthogonal spreading codes may also be utilized to achieve additional channelization over the air interface. Further the network may be an Evolved High Rate Packet Data (E-HRPD) network. Any appropriate radio interface may be employed by the various embodiments.

FIG. 2 illustrates a sequence of super frames 200 useful for communicating in the wireless communication systems of the various embodiments. In FIG. 2, the super frame sequence generally comprises a number of super frames 210, 220, 230, etc., wherein each super frame comprises a number of frames. For example, super frame 210 comprises a frame 212 having a resource assignment control channel portion within a control channel portion 214 and a data channel portion 216.

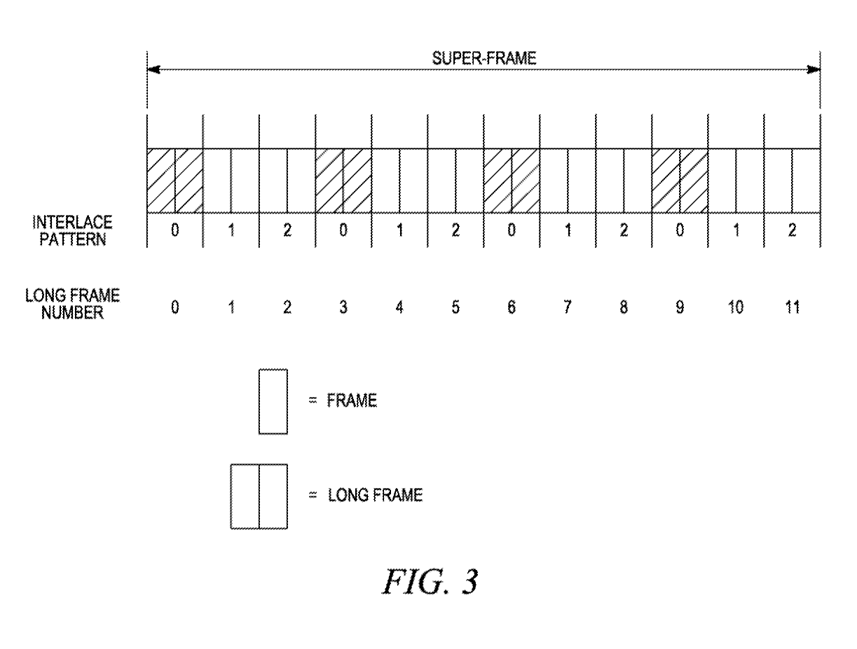

FIG. 3 illustrates a sequence of repeating long frames, wherein two frames are grouped to form a long frame. In some embodiments, a long frame is equivalent to a single frame. An interlace pattern is defined as a sequence of regularly distanced long frames. For systems employing synchronous hybrid automatic repeat request (HARQ) (S-HARQ), the initial and subsequent transmissions typically occur in the same interlace pattern. In the example illustrated by FIG. 3, 12 long frames, denoted long frame 0 through 11, make up a super-frame. In some embodiments, each super-frame may also include a preamble having pilot and other overhead channels.

For orthogonal frequency division multiple access (OFDMA) systems, the frequency domain is divided into subcarriers. For example, a 5 MHz OFDMA carrier, may be divided into 480 subcarriers, with a subcarrier spacing of 9.6 kHz. An OFDMA frame may be divided into multiple OFDM symbols. For example, a frame may occupy 0.91144 msec and contain 8 OFDM symbols, where each symbol occupies approximately 113.93 μsec. The subcarriers are grouped to form block resource channels (BRCH) and distributed resource channels (DRCH). A BRCH is a group of contiguous subcarriers that may hop within a larger bandwidth, while a DRCH is a group of noncontiguous sub-carriers.

In the various embodiments, the base station controller 109, the base stations 103, or some other network infrastructure component groups mobile stations 101 into one or more groups for scheduling purposes. The mobile stations 101 may be grouped based on radio channel conditions associated with the mobile stations, for example, channel quality information reported by the mobile stations, Doppler reported by the mobile stations, distance from the serving cell, etc. Alternatively, or additionally, the mobile stations 101 may be grouped based on one or more mobile station operating characteristics other than participation in a common communication session. Exemplary mobile station operating characteristics include power headroom of the mobile stations, macro diversity considerations, mobile station capability, service of the mobile station, codec rate, etc. Further, mobile stations with an active VoIP session may be grouped together. A mobile station may be a member of more than one group to facilitate handoffs between cells, for improving coverage, or other purposes.

After the group of mobile stations has been determined, the base station 103 sends an indication to the mobile stations 101 of each mobile station's position in the group and an indication of the group identifier. A control channel may be used to send the indications. The base station 103 may use the group identifier to send control information valid for the entire group. For example, the base station 103 may change the frequency allocation for the group by sending an indication of the group identifier and an indication of the new frequency allocation. The position indications may be sent to each mobile station separately or may be sent to several mobile stations at once.

For example, the base station 103 may send a list of wireless mobile station unique identifiers along with a group identifier. Any appropriate rule may be used to determine the position indication, for example, the first mobile station in the list of unique identifiers may be assigned the first position, the second mobile station in the list of unique identifiers may assigned the second position, etc. The mobile station unique identifier may be an Electronic Serial Number (ESN), a subscriber hardware identifier, a Medium Access Control Identifier (MAC-Id), or any other suitable identifier that uniquely identifies a particular mobile station.

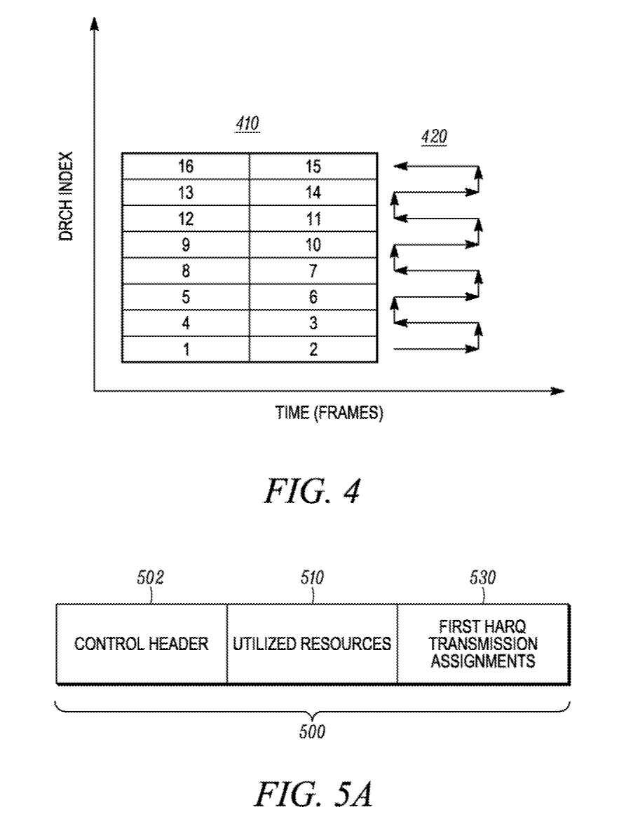

For each mobile station group, a scheduling function of the base station controller 109, or base station 103, may assign a set of time-frequency resources to be shared by the mobile stations in the group. FIG. 4 shows an exemplary set of shared resources. In FIG. 4, the shared resources 410 are two frames (one long frame) and eight distributed resource channels (DRCHs). If a block is defined as one frame in the time domain and one DRCH in the frequency domain, then there are 16 blocks or resources, numbered 1 through 16. As previously discussed, a DRCHs is a group of non-contiguous subcarriers, so the DRCH Index which is the vertical axis of FIG. 4, is a logical representation of the frequency domain. As will be discussed later, each mobile station determines its portion of the shared resource, based on the assignments for other mobile stations. Therefore, it is necessary to define the order in which the resources are to be allocated. In FIG. 4, an illustrative ordering pattern 420 is given which results in the blocks being numbered 1 through 16 as shown. The set of shared resources may be repeatedly used in an interlace pattern as described with respect to FIG. 3. For example, the 16 resources may be repeatedly used in each long frame of interlace pattern 0 in FIG. 3. Again, the 16 resources illustrated by FIG. 4 are logical representations of a set of sub-carriers in the frequency domain in a frame. It is to be understood that the exact physical location of these sub-carriers may change from frame to frame.

An indication of the set of shared resources and the ordering pattern may be signaled from the base station 103 to the mobile stations 101 using a control channel. Further, the control channel may be transmitted in any frame with a pre-defined relationship with the beginning frame of the set of shared resources. The set of shared resources may begin in the same frame the control channel is transmitted, may have a fixed starting point relative to the frame that the control channel is transmitted, or may be explicitly signaled in the control channel.

After the mobile stations are grouped and assigned a position (also called location) within the group, and a set of shared resources is assigned to the group, the base station 103 must indicate which mobile stations are active in a given time period, and, in some embodiments, the number of assigned resources assigned to each mobile station.

The methods and apparatuses described herein may be applied to both the forward link (FL) or downlink (base station to mobile station) and the reverse link (RL) or uplink (mobile station to base station) operation.

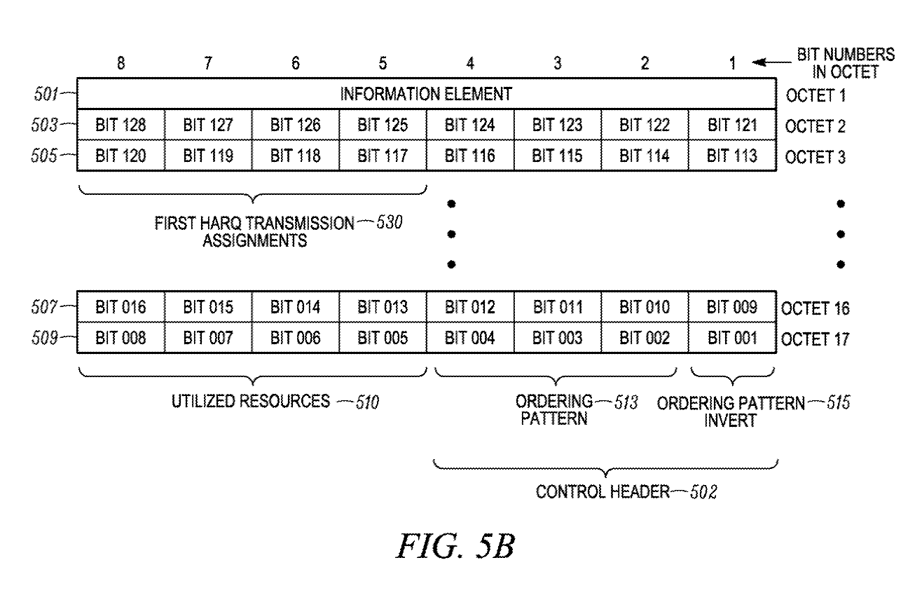

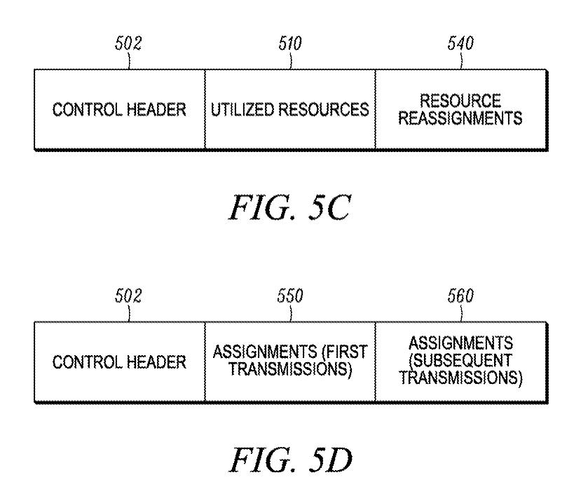

Forward link operation will now be described as follows. FIG. 5a illustrates how resource assignments may be indicated to mobile stations 101. In FIG. 5, message 500 comprises a first message field, control header 502, which indicates control information relating to the shared resources or control information relating to the users within the group as will be described further below. A second message field, utilized resources 510, indicates which of the set of shared resources are being used, that is, currently in use. A third message field, first HARQ transmission assignments 530, is used to allocate persistent resources as will be described further below.

FIG. 5b provides an example of further details of the message of FIG. 5a and shows how the message 500 may convey information using bit mapping. FIG. 5b represents an information element 501 which as discussed above, may be sent to the mobile station over a control channel. In the case of a mobile station group as discussed above, the information element 501 may be sent using a shared control channel. The information element 501 may comprise a number of octets as shown, and may vary in size depending on, for example, the number of mobile stations in a group, sharing the control channel. Therefore, the information element 501 may be any appropriate size for conveying the necessary information to the mobile station group.

Thus, the utilized resources field 510 may comprise a number of bitmap fields, for example Bits 005 through bit 008 of octet 17, item 509, as shown in FIG. 5b. In the example illustrated, each resource within the set of shared resources corresponds to a bitmap position in the utilized resources field. For example, the mobile stations decoding the shared control channel can determine which of the set of shared resources are currently in use according to the utilized resources field 510. For example, if there are four resources in the set of shared resources, with the first resource corresponding to bit 005 of octet 17, the second resource corresponding to bit 006 of octet 17, the third resource corresponding to bit 007 of octet 17, and the fourth resource corresponding to bit 008 of octet 17, then each mobile station may determine which of the four shared resources are in use by checking bits 005-008 of octet 17. A used resource indication may be provided by using either a binary “0” or a “1”, where available resources are indicated using the opposite state, or some other appropriate binary values may be used.

In some embodiments, at least one of the bits in the utilized resources field 510 is defined as a group control bit and is used to indicate the presence of a group control message valid for the entire set mobile stations in the group. When the group control bit indicator is a binary ‘1’ or some other appropriate value, each mobile station decodes a control message on the resource corresponding the group control bit indicator. When the group control bit is, for example, a ‘0’, the resource is available for regular data. The group control message may contain information relating to the set of shared resources, position reassignments for particular mobile stations, additional traffic resource assignments for particular mobile stations, or any other control information.

The control header 502 is used to convey control information relevant to either the shared resources or the users in the group. In some embodiments, the control header 502 includes a single bit denoted the “ordering pattern invert field” 515. For example, the binary value of a bit, such as Bit 001, may indicate whether to follow a specifically designated ordering pattern in ascending or descending order. Thus, a binary ‘0’ may indicate that the mobile stations should use a first designated ordering pattern in ascending order (not inverted), while a binary ‘1’ may indicate that the ordering pattern should be inverted, that is, in descending order.

In other embodiments, several ordering patterns may be established, and the base station 103 may indicate the ordering pattern to be used by the mobile station 101 group via ordering pattern field 513 of the control header 502. Therefore the base station 103 may indicate the desired ordering pattern during each scheduling instance. Further, the ordering pattern may be established at call setup and not signaled as part of the control header 502. Thus, in FIG. 5b, Bits 002, 003 and 004 may form the ordering pattern field 513 for designating the appropriate ordering pattern, and Bit 001 may form an ordering patter invert field 515 for indicating whether the ordering pattern is in ascending or descending order.

In FIGS. 5a and 5b, the first HARQ transmission assignments field 530 indicates radio resource assignment weighting information, and may also indicate a proportion of radio resources assigned, to the mobile stations. The radio resource assignment weighting information may also indicate a specified number or size of radio resources assigned to each mobile station.

In some embodiments wherein hybrid automatic repeat request (HARQ) is utilized, resources are allocated, that is, the size of the allocation (the number of blocks) is only indicated, for the first transmission in a series of HARQ transmission opportunities. Further, resources are allocated in a persistent manner. A persistent allocation means that the same mobile station will be assigned the same resource until a timer elapses, a call burst is completed, the packet is acknowledged, or until the base station 103 assigns the resource to another mobile station.

In particular, a first HARQ transmission assignments field 530 is used to allocate resources to those mobile stations for which a first HARQ transmission opportunity is defined. The first HARQ transmission assignments field 530 may include one bit per mobile station for which a first HARQ transmission opportunity is defined, indicating whether that mobile station is assigned a resource. If a single bit is used for the first HARQ transmission assignments field 530, the base station transmits data to the Nth mobile station indicated as active in the first HARQ transmission assignments field on the resource corresponding to Nth unused resource in the utilized resources field 510, where N is a positive integer. The resources are allocated in a persistent manner as described above.

Alternatively, the first HARQ transmission assignments field 530 may include two bits per mobile station, indicating the number of assigned resources, wherein binary “00” indicates no transmission, and “01,” “10” and “11” indicate transmissions occupying various numbers of resources. For example, “01” may correspond to a single resource, “10” may correspond to two resources, and “11” may correspond to three resources. It is also to be understood that a nonlinear mapping may also be used. For example, “01” may correspond to a single resource, “10” may correspond to two resources, and “11” may correspond to four resources.

If multiple bits are used in the first HARQ transmission assignments field 530, the base station transmits data to the Nth mobile station indicated as active in the first HARQ transmission assignments field using the corresponding number of resources beginning with the M+1th unused resource, where M is the total number of resources allocated for the previous N−1 mobile stations, where N is a positive integer and M is a non-negative integer.

In some embodiments, the radio resource assignment weighting information may also include vocoder rate, modulation, or coding information. Again, the resources are allocated in a persistent manner as described above. A persistent assignment made during the long frame corresponding to one instance of a mobile station's first HARQ transmission opportunity may last beyond the long frame corresponding to the next instance of a mobile station's first HARQ transmission opportunity. Such an implementation allows the base station to simultaneously transmit two packets to the same mobile station. This technique is sometimes referred to herein as concurrent transmissions.

The information element 501 which contains the control header 502 (if used), the utilized resources field 510, and the first HARQ transmission assignment field 530 is sent to the mobile station group over the shared control channel. Also, as discussed above, the mobile station group also shares a set of time-frequency resources. The shared control channel is typically transmitted by the base station 103 in each long frame for assigning resources within the long frame, although it is understood that the shared control channel could be transmitted by the base station 103 in any preceding long frame.

For some applications including voice, packets arrive at a relatively constant rate. For a VoIP application for example, vocoder frames may arrive approximately every 20 ms. Referring again to FIG. 3, for a VoIP application, vocoder frames may arrive approximately every 20 ms beginning at the start of long frame number 0. The base station adds header data to the vocoder frame and encodes the frame to form a voice packet. The base station then modulates and transmits at least a portion of the symbols comprising the voice packet to the mobile station in long frame number 0. This transmission is referred to as the first transmission.

The mobile station receiving the packet will attempt to decode it to obtain the voice information. If the mobile station successfully decodes the voice packet obtained from the first transmission, the mobile station will send an acknowledgement (ACK) message to the base station. Upon receiving an ACK, the base station will not transmit any additional information, that is, will not retransmit, the voice packet to the mobile station in long frames 3, 6, and 9. In fact, the utilized channels field 510, allows these resources to be used by other mobile stations. However, if the mobile station was not able to successfully decode the voice packet, it sends a negative acknowledgement (NACK) message to the base station.

The base station will, upon receiving the NACK message, send additional symbols of the voice packet to the mobile station in long frame number 3. This is referred to as the second transmission. If the mobile station successfully decodes the voice packet after the second transmission, it may send an ACK message to the base station. Upon receiving the ACK message, the base station will refrain from transmitting any additional information to the mobile station in long frames 6 and 9. However, if the mobile station was not able to successfully decode the voice packet, it will send a NACK message to the base station which will, in response, send additional symbols of the voice packet in the third transmission, in long frame number 6. In some embodiments, NACKs are indicated by not transmitting an ACK, thus by having no response, the mobile station may indicate a NACK response.

Similarly the mobile station may send an ACK or NACK message depending upon its successful decoding of the third transmission, and for a NACK message the base station will send additional symbols of the voice packet in the fourth transmission, in long frame number 9. Again the mobile station may send an ACK or NACK message depending upon its success in decoding the packet. If persistent allocations are used, the base station will transmit data to the mobile station on the same time-frequency resources in long frames 0, 3, 6, and 9.

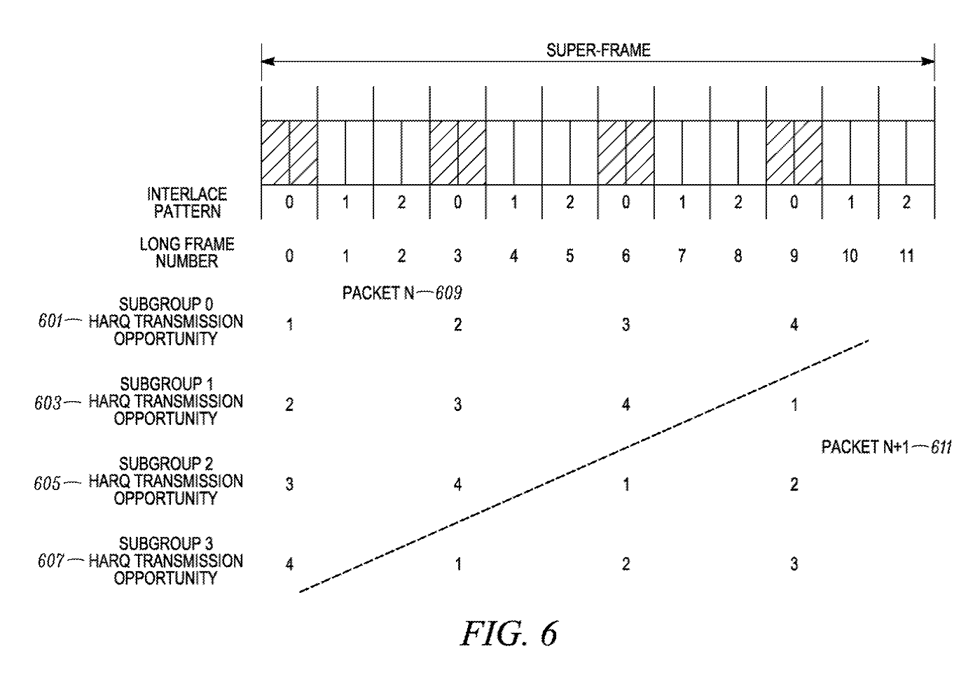

To facilitate persistent assignments that are indicated only on the first HARQ transmission, a predetermined relationship between group position and HARQ transmission opportunity is required. FIG. 6 illustrates an example of this predetermined relationship in accordance with various embodiments.

In the embodiments exemplified by FIG. 6, a primary mobile station group is further subdivided into four subgroups, where each subgroup is assigned a particular sequence for its HARQ transmission opportunities. Thus, FIG. 6 illustrates two consecutive encoded packets denoted as packet N 609, and packet N+1 611, where N is a positive integer. The base station may thus define the first, second, third, and fourth HARQ transmission opportunities of packet N for subgroup 0 601 to occur in long frame numbers 0, 3, 6, and 9, respectively as shown. Similarly, the base station may define the second, third, and fourth HARQ transmission opportunities of packet N and the first HARQ transmission opportunity of packet N+1 for subgroup 1 603 to occur in long frame numbers 0, 3, 6, and 9 respectively as shown.

If a mobile station is assigned to more than one subgroup, then the base station may begin transmitting a packet to the mobile station during multiple long frames of the same superframe. This allows the base station to simultaneously transmit more than one packet to a particular mobile station during a given long frame. For example, the base station may transmit the second HARQ transmission of one packet, while transmitting the first HARQ transmission of a second packet during a particular long frame. Further, various types of mobile stations may support different numbers of simultaneous packet transmissions, depending on mobile station processing capabilities. Therefore, a mobile station may indicate to the base station the numbers of simultaneous packet transmissions that it is able to decode. The indication may be a capability attribute of the mobile station, which may be sent to the base station on a control channel.

Returning now to FIG. 6, the process is repeated as shown in FIG. 6 for subgroups 2 605 and 3 607. The particular sequences of HARQ transmission opportunities repeat at a known interval, for example in each superframe as shown in FIG. 6, for subsequent packets. Based on the established relationships between the subgroups and the HARQ transmission opportunities, the base station may allocate mobile stations to the subgroups in a systematic way based on group position.

For example, for a mobile station group of size “K,” the base station may define the first K/4 group positions to belong to subgroup 0, the second K/4 group positions to belong to subgroup 1, the third K/4 group positions to belong to subgroup 2, and the last K/4 group positions to belong to subgroup 3. In another embodiment, subgroup 0 may correspond to every fourth group position beginning with the first group position, subgroup 1, or may correspond to every fourth group position beginning with the second bitmap position, etc.

In an alternate embodiment, the base station explicitly assigns each mobile station to one or more subgroups. For example, if there are four subgroups, then each mobile station may be allocated to two of the four subgroups. In this way, the base station may begin transmitting packets to each mobile station in two of the four long frames that make up an interlace pattern. In a related embodiment, all mobile stations are assigned to all subgroups, which allows the base station to begin transmitting a packet in each long frame that makes up an interlace pattern. The control channel overhead is smallest when each mobile station is only assigned to one subgroup and is largest when each mobile station is assigned to all subgroups. On the other hand, the potential delay is largest when each mobile station is only assigned to one subgroup and is smallest when each mobile station is assigned to all subgroups. Therefore, the base station may assign a mobile to one or more subgroups to tradeoff control channel overhead versus delay. The base station need not assign all mobile stations to the same number of subgroups. For example, a mobile station may be assigned to more than one subgroup in order to reduce delays, where the determination is made based on parameters determined by the base station such as, but not limited to, the QoS value of the service, a value describing the delay through the network, measured delays, as well as the level of service the users subscribes to from the operator.

For all of the various embodiments, it is important to understand that a predetermined relationship between group position and HARQ transmission opportunity, enables each mobile station in the group to a priori know the HARQ transmission opportunity for all other members of the group. The predetermined relationship may be transmitted from the base station to the mobile stations on a control channel or may be stored at the mobile station, for example in memory.

In some embodiments, the base station establishes a criterion for which mobile stations will be assigned to each subgroup. One possible criterion is to place mobile stations into subgroups according to their position with the coverage area 107 or, more specifically, the mobile station's forward link geometry. Such position information may be determined from channel quality information reported from the mobile station. For example, mobile stations with forward link geometries less than −1.5 dB can be placed into subgroup 0, mobile stations with forward link geometries between −1.5 dB and 0 dB can be placed into subgroup 1, mobile stations with forward link geometries between 0 dB and 3 dB can be placed into subgroup 2, and mobile stations with forward link geometries greater than 3 dB can be placed into subgroup 2. The mobile station is initially placed into one of these subgroups when the group position is assigned. In this embodiment, there may be an unequal number of mobile stations assigned to each subgroup. Further, the assigned group position may not have a known relationship to the assigned subgroup. Consequently, the base station may indicate to the mobile station its assigned subgroup and assigned subgroup position.

Further, the first HARQ transmission assignments field 530 can have a different size in each long frame of a particular interlace pattern depending on the number of mobile stations assigned to the subgroup for which a first HARQ transmission opportunity is defined. Once the utilized resource field 510 and the first HARQ transmission assignments field 530 are determined and ready to be transmitted, the amount of coding and transmit power is set based on the channel quality information for the users in the subgroup for which a first HARQ transmission opportunity is defined. Since the subgroups were constructed by considering the geometry of the mobile station forward links, different amounts of coding and transmit power are required in each long frame of an interlace pattern. The base station may move mobile stations from one subgroup to another subgroup as the mobile station's geometry changes, using a subgroup change message.

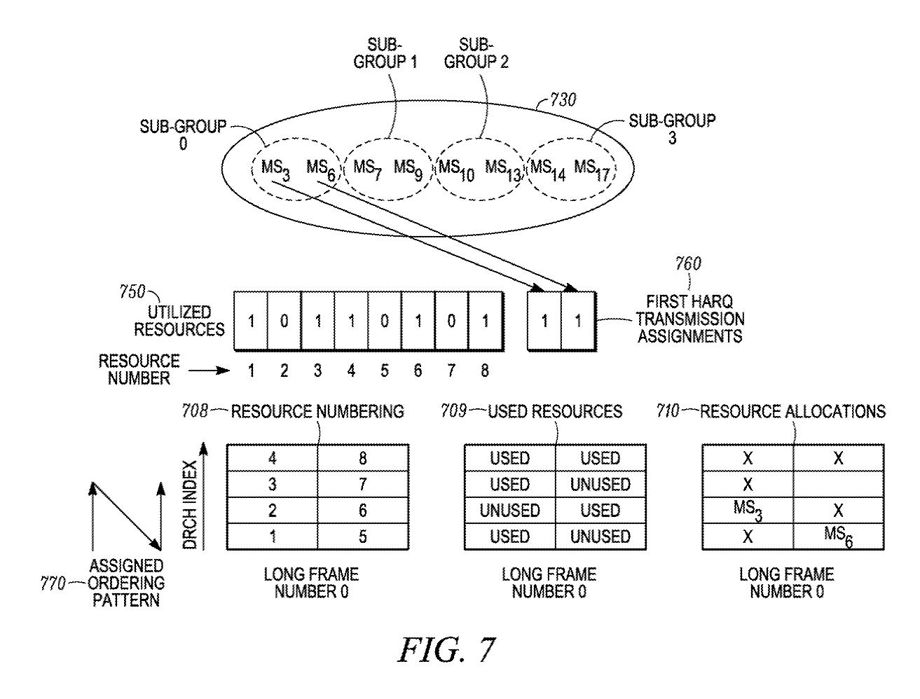

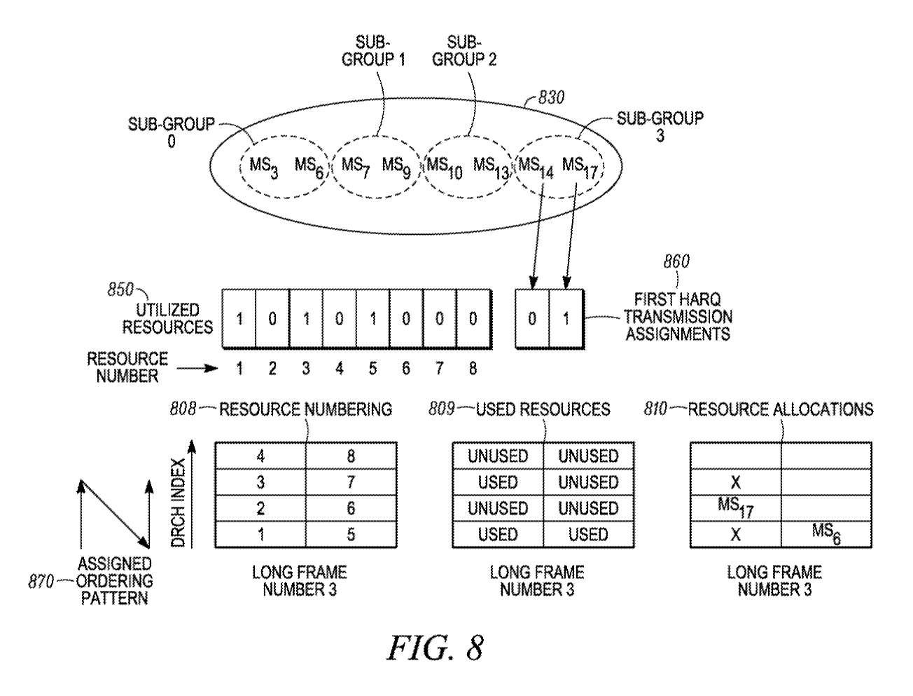

FIG. 7 and FIG. 8 illustrate exemplary allocation policies of the various embodiments having the utilized resources field 510 and the first HARQ transmission assignments field 530. FIG. 8 assumes a moment in time subsequent to the example shown in FIG. 7, that is, a snapshot of long frame number 3 wherein the scenario depicted in FIG. 7 is a snapshot of long frame number 0.

Referring to FIG. 7, eight mobile stations are assigned to a group 730 and are assigned group positions 1 through 8. Mobile station 3 (MS₃) is assigned group position 1, MS₆ is assigned group position 2, MS₇ is assigned group position 3, MS₉ is assigned group position 4, MS₁₀ is assigned group position 5, MS₁₃ is assigned group position 6, MS₁₄ is assigned group position 7 and MS₁₇ is assigned group position 8.

Group positions 1 and 2 are assigned to subgroup 0, group positions 3 and 4 are assigned to subgroup 1, group positions 5 and 6 are assigned to subgroup 2, and group positions 7 and 8 are assigned to subgroup 3. The relationship between the subgroups and the HARQ transmission opportunities are similar to those shown in FIG. 6. In addition to assigning position information, the base station transmits to group 730 an indication of the set of shared resources 708 and an assigned ordering pattern 770 indicating the order in which the resources 708 are allocated. This information may be transmitted from the base station to the mobile stations on a control channel. When the assigned ordering pattern 770 is applied to the set of shared resource 708, the resources are numbered as shown in 708.

The base station transmits the utilized resources field 750 and the first HARQ transmission assignments field 760 as part of the shared control channel. The utilized resources field is a length 8 bitmap, where each bitmap position corresponds to one of the shared resources. In particular, the first bitmap position corresponds to the first shared resource, the second bitmap position corresponds to the second shared resource, etc. A ‘1’ in the utilized resources field 750 indicates that the corresponding resource in the set of shared resources is currently being used for an ongoing transmission, while a ‘0’ in the utilized resources field 750 indicates that the corresponding resource in the set of shared resources is currently not being used for an ongoing transmission, and is therefore available for a first transmission. Based on the utilized resources field, the mobile stations in the group determine which resources are being used for ongoing transmissions as depicted in 709. The first HARQ transmission assignments field 760 is a length 2 bitmap, where each bitmap position corresponds to a mobile station for which a first HARQ transmission opportunity is defined. In this example, a ‘1’ in the first HARQ transmission assignments field 760 indicates that the corresponding mobile station is allocated one of the set of shared resources, while a ‘0’ in the first HARQ transmission assignments field 760 indicates that the corresponding mobile station is not assigned one of the set of shared resources. The first bitmap position of the first HARQ transmission assignments field 760 is associated with the first mobile station in the subgroup, while the second bitmap position of the first HARQ transmission assignments field 760 is associated with the second mobile station in the subgroup. In this example, the mobile station corresponding the Nth ‘1’ in the first HARQ transmission assignments field 760 is allocated the Nth unused resource as defined by the utilized resources field 750.

Based on these rules, for long frame number 0, the base station allocates resources from the set of shared resources 708 to subgroup 0 in a persistent manner as shown in 710. In particular, MS₃ is allocated the first unused resource of 709, and MS₆ is allocated the second unused resource of 709. An ‘X’ in the resource allocations 710 indicates that a resource is being used by another mobile station.

The base station will encode and send the utilized resources field 750 and the first HARQ transmission assignments field 760 over the shared control channel. The mobile stations receive and decode the shared control channel to determine the mobile station utilized resources field 750 and the first HARQ transmission assignments field 760. For example, based on the long frame number, MS₃ and MS₆ determine that a first HARQ transmission opportunity is defined for them. Next, MS₃ and MS₆ determine which of the set of shared resources are currently being used for ongoing transmissions from the utilized resources field 750. Next, based on the first HARQ transmission assignments field 760, MS₃ may determine that it is the first mobile station allocated resources from the set of unused resources and that it is allocated one resource. Therefore, MS₃ determines its resource allocation as shown in 710. Likewise MS₆ may determine that it is the second mobile station allocated resources from the set of unused resources and that it is allocated one resource. MS₆ determines that one resource was previously allocated and therefore determines its allocation as shown in 710.

FIG. 8 shows example allocations for long frame number three. Referring again to FIG. 6, the base station allocates resources to subgroup 3 for their first HARQ transmission opportunity, subgroup 0 for their second HARQ transmission opportunity, subgroup 1 for their third HARQ transmission opportunity, and subgroup 2 for their fourth HARQ transmission opportunity. As depicted in FIG. 8, the mobile stations in subgroup 3 now correspond to the bitmap positions of the first HARQ transmission assignments field 860.

For example, MS₆ may have sent a NACK message to the base station, while MS₃ may have sent an ACK message. Further, the base station may have a new packet to transmit, for example, to MS₁₇ but not to MS₁₄. The base station will thus send the utilized resources field 860 indicating which of the set of shared resources are currently being used and the first HARQ transmission assignments field 860 indicating which of the mobile stations for which a first HARQ transmission opportunity is defined are being allocated one of the shared resources. Because MS₆ sent a NACK, and because the base station allocates resources in a persistent manner, MS₆ will be allocated resource number 5 in long frame number 3. The base station indicates to the other mobile stations that resource number 5 is being used for an ongoing transmission using the utilized resources field 850. Because MS₃ sent an ACK, the base station indicates to the other mobile stations that resource number 2 is not being used for an ongoing transmission using the utilized resources field 850.

The base station encodes and sends the utilized resources field 850 and the continuation field 860 on the shared control channel. Based on the long frame number, MS₁₄ and MS₁₇ determine that a first HARQ transmission opportunity is defined for them. Next, MS₁₄ determines that it is not allocated one of the shared resources based on the first HARQ transmission assignments field 860, while MS₁₇ determines that it is allocated one of the shared resources based on the first HARQ transmission assignments field 860. Then, MS₁₇ determines which of set of shared resources are currently being used for ongoing transmissions from the utilized resources field 850. Next, based on the first HARQ transmission assignments field 860, MS₁₇ may determine that it is the first mobile station allocated resources from the set of unused resources and that it is allocated one resource. Therefore, MS₁₇ determines its resource allocation as shown in 810.

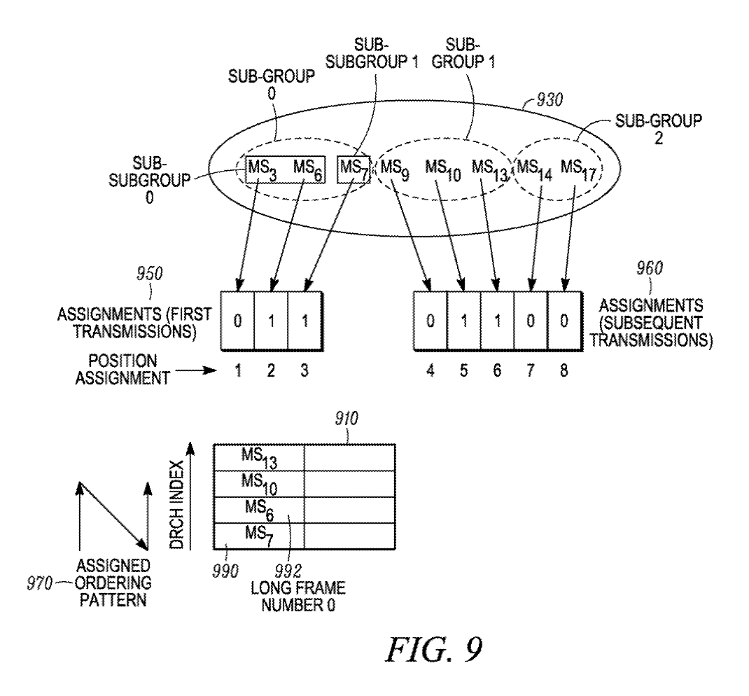

FIG. 9 illustrates exemplary allocation policies of the various embodiments having the assignments (first transmissions) field 550 and the assignments (second transmission) field 560. For example, referring to FIG. 9, within sub-group 0, two sub-subgroups are defined, namely sub-subgroup 0 and sub-subgroup 1. The mobile stations within sub-subgroup 0 are assigned a group position, which is further associated with one of the shared time-frequency resources when the sub-group is allocated its first HARQ transmission opportunity.

Referring to FIG. 9, the first position is associated with the first shared resource 990. The second position is associated with the second shared resource 992. If the first position is indicated with a ‘1’, then the mobile station associated with position 1 is assigned the shared resource associated with position 1 990. If the first bitmap position is indicated with a ‘0’, then the remaining mobile stations know what the mobile station associated with bitmap position 1 is not being served during this long frame, and therefore also know that the associated resource is available. A similar relationship exists for the second bitmap position. In this illustrative example, the assignments (first transmissions) has one bit per mobile station with a ‘1’ indicating that one resource is assigned and a ‘0’ indicating that no resources are assigned.

Because the first position is indicated with ‘0’, the remaining mobile stations know that the first shared resource 990 is not currently being used by MS₃ and therefore also know that the first shared resource 990 is available. Further, because the second bitmap position is indicated with ‘1’, the remaining mobile stations know that the second shared resource 992 is currently being used by MS₆ and therefore also know that the second shared resource 992 is not available. In particular, MS₇ knows to begin allocating resources with the first shared resource, while MS₁₀ knows to skip second shared resource 992 when allocating resources. The size of the first sub-sub-groups can vary from zero to the size of the entire sub-group, where the size of the first sub-subgroup may be indicated on a control channel, indicated in the same message as the assignments (first transmissions) field, or may be based on a predefined rule dependent on the size of the sub-group.

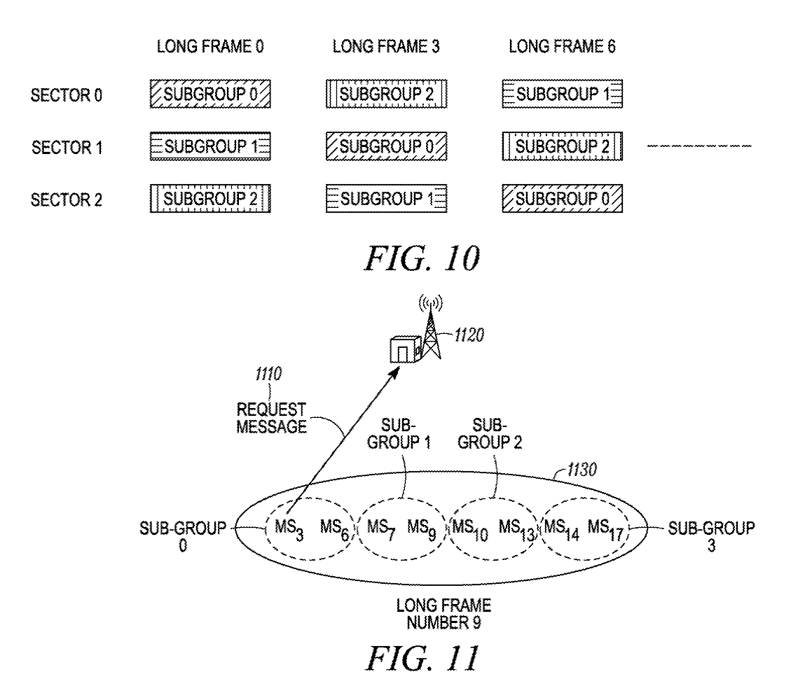

In some embodiments, different base stations may define their subgroups such that the first transmission opportunity for the low geometry subgroup is located in a different long frame in neighboring base stations. As an example, consider the scenario where each base station 103 has three sectors within its coverage areas 107, where the three sectors are denoted sector 0, sector 1, and sector 2. FIG. 10 illustrates how the first HARQ transmission opportunities may be defined for different subgroups in different sectors.

Thus three subgroups may be defined, namely subgroup 0, subgroup 1, and subgroup 2, where subgroup 0 is the low geometry subgroup, subgroup 1 is the medium geometry subgroup, and subgroup 2 is the high geometry subgroup. Referring to FIG. 10, in sector 0, resources are allocated for first HARQ transmission opportunities for subgroups 0, 1, and 2 in long frame 0, 6, and 3, respectively. In sector 1, resources are allocated for first HARQ transmission opportunities for subgroups 0, 1, and 2 in long frame 3, 0, and 6, respectively. In sector 2, resources are allocated for first HARQ transmission opportunities for subgroups 0, 1, and 2 in long frame 6, 3, and 0, respectively.

Such a structure is advantageous for averaging the impact of other sector interference. In particular, only one in three sectors are transmitting the shared control channel containing the utilized resource field 510 and the first HARQ transmission assignments field 530 to the low geometry subgroup during a particular long frame.

In a related embodiment, each member of the subgroup corresponding to the mobile stations with the lowest geometry, denoted the low geometry subgroup, is assigned a persistent resource for the duration of the VoIP call. In this embodiment, during the long frames for which a first HARQ transmission opportunity is defined for the low geometry subgroup, the first HARQ transmission assignments field 530 is replaced with the resource reassignments field 540 as depicted in FIG. 5c. In an exemplary embodiment, each resource within the set of shared resources corresponds to a bitmap position in the resource reassignments field 540. During these long frames, each mobile station decodes the shared control channel and extracts the utilized resources field 510 and the resource reassignments field 540. The low geometry subgroup determines if it is assigned one of the shared resources by checking the bit corresponding to its assigned persistent resource in the utilized resources field 530.

If the bit is ‘1’, the base station is transmitting a packet to the mobile station. If the bit is ‘0’, the base station is not transmitting a packet to the mobile station. If mobile stations belonging to the low geometry subgroup are unable to decode the shared control channel, these mobile stations may assume that the base station is transmitting a packet, thereby eliminating the necessity of these mobile stations to decode the shared control channel. It is still advantageous for the low geometry subgroup mobile stations to decode the shared control channel, because, if the base station is not transmitting a packet to the mobile station, the mobile station may enter a reduced power mode until its next first HARQ transmission opportunity is defined.

The remaining mobile stations determine a new resource assignment as follows. The mobile station previously assigned the resource corresponding to the Nth ‘1’ in the resource reassignments field 540 is assigned the resource corresponding the Nth ‘0’ in the utilized resources field 510. This resource assignment may be persistent. In the example above, the utilized resources field 510 and the resource reassignments field 540 were used during the long frames in which a first HARQ transmission opportunity was defined for the low geometry subgroup. In an alternate embodiment, the utilized resources field 510 and the resource reassignments field 540 are used in each long frame to assign resources.

In the various embodiments described above, multicast from base stations in two different coverage areas 107 may be accomplished according to the following procedure. First, a mobile stations is assigned a group position in a first coverage area 107 as previously described. When it is determined that multicasting from both the base station in both the first coverage area and the second coverage area is advantageous, the base station in the first coverage area transmits the current packet and the current resource assignment for a particular mobile station to the base station in the second coverage area. Note that if the base station in the first coverage area and the base station in the second coverage area may be the same. The base station in the second coverage area sets the bit corresponding to the resource indicated from the base station in the first coverage area to ‘1’ in its utilized resources field 510 and transmits the current packet for the targeted mobile station on the resource indicated from the base station in the first coverage area. Note that the mobile station is not assigned a group position in the second coverage area.

In some embodiments, the shared control channel is comprised of the assignments (first transmissions) field 550 and the assignments (subsequent transmission) field 560 as shown in FIG. 5d. In this embodiment, each mobile station is associated with either a bit in the assignments (first transmissions) field 550 or the assignments (subsequent transmission) field 560. In this embodiment, the base station may establish two sub-subgroups within each subgroup, where the base station associates a particular resource block with each member of first sub-subgroup (sub-subgroup 0) when a first HARQ transmission opportunity is defined for the subgroup. If the bit corresponding to a mobile station in the first sub-subgroup of the subgroup for which a first HARQ transmission opportunity is defined is set to ‘1’, then that mobile station is allocated the associated resource. The Nth mobile station in the set of mobile stations in second sub-subgroup of the subgroup for which a first HARQ transmission opportunity is defined and the mobile stations in the remaining subgroups are assigned the Nth resource not allocated for the first sub-subgroup of the subgroup for which a first HARQ transmission opportunity is defined.

In some embodiments, mobile stations assigned to a subgroup are periodically given an additional transmission opportunity, which may be needed for situations where the super frame 210 is longer than the voice frame, to mitigate accumulating delays in transmission. To address this, an additional bit is assigned to a mobile station every Nth transmission opportunity. Thus for illustration, consider MS₃ of sub-group 0 in 730, wherein every fourth occurrence (N=4) of this mobiles first transmission opportunity, the bitmap 760 will have an additional bit corresponding to MS₃ appended to the end of bitmap 760, and ordered so that mobile station MS₃ may identify this second assignment bit. The subsequent mapping of this additional transmission assignment will be the same as in the previous examples. In an alternative implementation, the Pth additional bit, added every Nth transmission opportunity, can be tied the Pth first HARQ assignment bit position in 760. These bits are typically appended onto the end of bitmap 760 and their existence and location are indicated in the control message.

In some embodiments, selected mobile stations may be given a first transmission assignment from a predefined resource, which is not necessarily part of the shared resources, and which is only available for selected mobiles on their first transmission. After the first transmission assignment is made, the mobile station on its second transmission is treated as any other mobile station having a first transmission assignment in bitmap 760, even though it is actually this mobile station's second transmission. The second and remaining transmissions of these selected mobile stations are given transmission assignments using bitmap 760, assigned resources 710, and the utilized resources are indicated using bitmap 750.

In another alternate embodiment, each mobile station is assigned a specific predefined resource, from resource allocation 710, that is always used when conveying the initial transmission to that mobile station, thus guaranteeing that the mobile station knows where its initial transmission will be located. In this embodiment, the utilized resources bitmap 750 contains a “1” in each bit location to indicate that the corresponding resource is conveying an initial transmission to the mobile station to which that corresponding resource was assigned. The assignment bitmap 760 also contains a bit for each of the transmission resources, but functions to indicate that the packet transmission that was using the corresponding resource in the immediately prior transmission opportunity is continued in the current transmission opportunity, though possibly on a different resource. These continuation transmissions are packed into the available resources that do not have a corresponding “1” in the utilized resources bitmap 750, using round-robin or other appropriate method that is either known in advance by the mobile station or signaled to the mobile station.

The reverse link operates in a manner analogous to the forward link with the fundamental differences highlighted and described in detail as follows. In general, for the forward link, the base station scheduling entity determines for which mobile stations to transmit data and uses the utilized resources field 510 and the first HARQ transmission assignments field 530 to indicate to the mobile stations in the group which of the mobile stations are receiving data. For the reverse link, the base station scheduling entity determines from which mobile stations to receive data and uses the utilized resources field 510 and the first HARQ transmission assignments field 530 to indicate to the mobile stations in the group which of the mobile stations have been granted a resource for transmitting data. There will be a separate utilized resources field 510 and the first HARQ transmission assignments field 530 for the forward link and the reverse link, although the entire set of fields may be encoded together in some embodiments.

The HARQ process of the reverse link is similar to that of the forward link with the roles of base station and mobile station reversed. Like the FL, the RL takes advantage of persistent assignments, and relies on a predetermined relationship between group position and HARQ transmission opportunity as depicted in FIG. 6.

As previously discussed, scheduling reverse link transmissions on orthogonal resources relies on a request/grant mechanism, whereby the mobile station requests a channel and the base stations grants, or refuses to grant, the request. FIG. 11 illustrates an exemplary request mechanism used by the mobile stations to request that the base station grant one of the set of shared resources for reverse link transmission. Referring to FIG. 11, eight mobile stations are assigned to a group 1130 and are assigned group positions 1 through 8. Mobile station 3 (MS₃) is assigned group position 1, MS₆ is assigned group position 2, MS₇ is assigned group position 3, MS₉ is assigned group position 4, MS₁₀ is assigned group position 5, MS₁₃ is assigned group position 6, MS₁₄ is assigned group position 7 and MS₁₇ is assigned group position 8.

The HARQ transmission opportunities are similar to those depicted in FIG. 6. During each long frame, only the mobile stations for which a first HARQ transmission opportunity is defined for the upcoming grant instance will transmit a request message. For example, if the base station grants resources for subgroup 0 in long frame number 0 of each superframe, then subgroup 0 will request resources in a preceding long frame, for example long frame number 9 of the preceding super-frame. More particularly, each mobile station is assigned a particular long frame and a particular OFDM resource for requesting its reverse link transmission. The OFDM resource for requesting resources can be particular OFDM subcarriers, particular OFDM symbols, a particular Walsh code on a set of OFDM subcarriers and OFDM symbols, or combinations.

Referring to FIG. 11, consider that subgroup 0 is assigned long frame number 9 for requesting reverse link resources. Further, consider that MS₃ has a packet to transmit on the reverse link, while MS₆ does not have a packet to transmit on the reverse link. Therefore, MS₃ transmits a request message 1110 to the base station 1120. Based on these request messages (or absence of request messages), the base station grants particular resources to particular mobile stations.

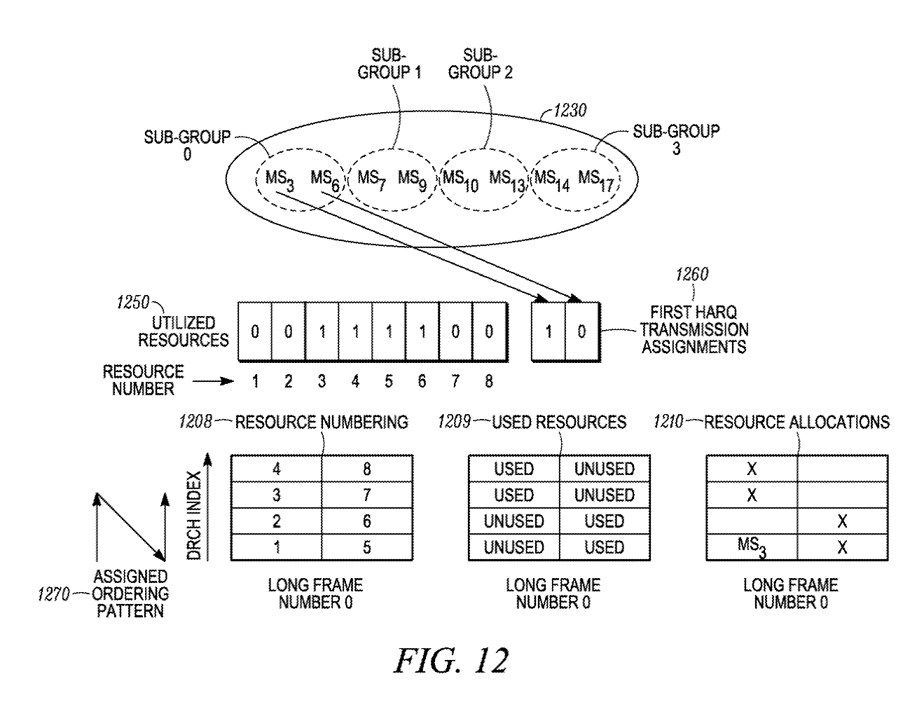

The resource allocation signaling for the RL is similar to that of the FL. To illustrate this, FIG. 12 depicts an exemplary allocation policy of the various embodiments having the utilized resources field 1210 and the first HARQ transmission assignments field 1230. The group assignments, subgroup assignments, and the relationship between the subgroups and the HARQ transmission opportunities are the same as those depicted in FIG. 12.

The base station transmits to group 1230 an indication of the set of shared resources 1208 and an assigned ordering pattern 1270 indicating the order in which the resources 1208 are allocated. Note the RL resources for a particular group may be the same as the FL resources or may be different from the RL resources. Further, the number of FL and RL resources may be the same or different. This information may be transmitted from the base station to the mobile stations on a control channel. When the assigned ordering pattern 1270 is applied to the set of shared resource 1208, the resources are numbered as shown in 1208.

The base station transmits the utilized resources field 1250 and the first HARQ transmission assignments field 1260 as part of the shared control channel. The utilized resources field is a length 8 bitmap, where each bitmap position corresponds to one of the shared resources. In particular, the first bitmap position corresponds to the first shared resource, the second bitmap position corresponds to the second shared resource, etc. A ‘1’ in the utilized resources field 1250 indicates that the corresponding resource in the set of shared resources is currently being used for an ongoing transmission, while a ‘0’ in the utilized resources field 1250 indicates that the corresponding resource in the set of shared resources is currently not being used for an ongoing transmission, and is therefore available for a first transmission.

Based on the utilized resources field, the mobile stations in the group determine which resources are being used for ongoing transmissions as depicted in 1209. The first HARQ transmission assignments field 1260 is a length 2 bitmap, where each bitmap position corresponds to a mobile station for which a first HARQ transmission opportunity is defined. In this example, a ‘1’ in the first HARQ transmission assignments field 1260 indicates that the corresponding mobile station is allocated one of the set of shared resources, while a ‘0’ in the first HARQ transmission assignments field 1260 indicates that the corresponding mobile station is not assigned one of the set of shared resources.

The first bitmap position of the first HARQ transmission assignments field 1260 is associated with the first mobile station in the subgroup, while the second bitmap position of the first HARQ transmission assignments field 1260 is associated with the second mobile station in the subgroup. In this example, the mobile station corresponding the Nth ‘1’ in the first HARQ transmission assignments field 1260 is allocated (granted) the Nth unused resource as defined by the utilized resources field 1250.

Based on these rules, for long frame number 0, the base station allocates (grants) resources from the set of shared resources 1208 to subgroup 0 in a persistent manner as shown in 1210. Recall from FIG. 11 that MS₃ requested a resource, while MS₆ did not a request a resource. Therefore, MS₃ is allocated (granted) the first unused resource of 1209, and MS₆ is not allocated (granted) a resource. An ‘X’ in the resource allocations 1210 indicates that a resource is being used by another mobile station.

The base station will encode and send the utilized resources field 1250 and the first HARQ transmission assignments field 1260 over the shared control channel. The mobile stations receive and decode the shared control channel to determine the mobile station utilized resources field 1250 and the first HARQ transmission assignments field 1260. For example, based on the long frame number, MS₃ and MS₆ determine that a first HARQ transmission opportunity is defined for them. Next, MS₃ and MS₆ determine which of set of shared resources are currently being used for ongoing transmissions from the utilized resources field 1250. Next, based on the first HARQ transmission assignments field 1260, MS₃ may determine that it is the first mobile station allocated resources from the set of unused resources and that it is allocated one resource. Therefore, MS₃ determines its resource allocation as shown in 1210. On the other hand, MS₆ may determine that it is not allocated a resource. Based on the assigned (granted) resources, the mobile stations will transmit packets on the RL using the granted resources. The base station also knows where to expect transmissions from each mobile station.

For reverse link operation, the base station may use the utilized resources field 510 to serve as an acknowledgement indication. In particular, once the mobile station is assigned a resource in a persistent manner for reverse link transmission, the base station will indicate a ‘1’ in the utilized resources field 510 until it successfully decodes the packet or until a maximum number of transmissions is reached. In this way, if the mobile station observes that the base station has changed the bit corresponding to its assigned resources from a ‘1’ to a ‘0’ before the maximum number of transmissions is reached, the mobile station knows that the base station successfully decoded the mobile station's packet.

Similar to the described operation on the forward link, the utilized resources field 510 and the first HARQ transmission assignments field 530 can be used to indicate concurrent transmission opportunities for one mobile station on the reverse link. However, due to power limitations at the mobile station, it is sometimes not desirable for the mobile station to simultaneously transmit two packets, especially for mobile stations located at the outer extremities of a coverage area 107. Therefore, in some embodiments, the control header 502 is used to indicate to a particular mobile station that is granted a resource in a different interlace or in a particular frame of the same interlace (i.e. in the frame for which a resource has not already been granted).

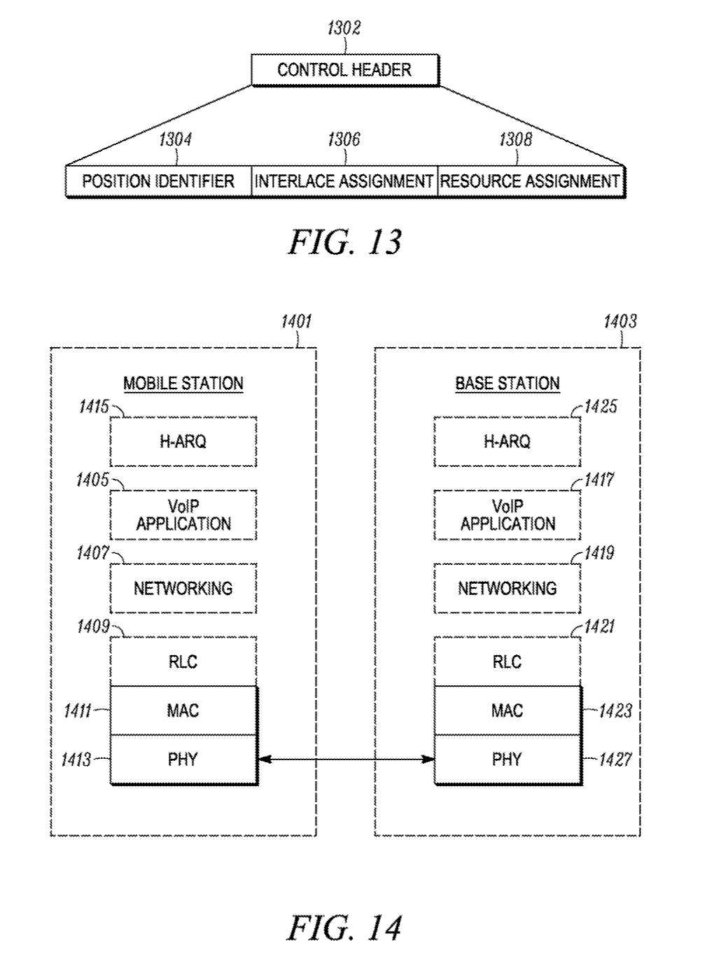

FIG. 13 illustrates an exemplary control header to grant a resource to the mobile station. Referring to FIG. 13, the control header 1302 contains three fields for granting a resource to the mobile station. First, position identifier field 1304 is used to indicate the position of the mobile station for which the grant is intended. Second, an interlace assignment field 1306 is used to indicate for which interlace the grant is valid. For example, the interlace assignment field 1306 could be 2 bits with ‘00’ indicating the current interlace, ‘01’ indicating the next interlace, and ‘10’ indicating the interlace after next.

Third, a resource assignment field 1308 is used to indicate the particular resource that has been granted. The grant indicated in the control header may be a persistent assignment as previously described. Multiple copies of the position identifier field 1304, the interlace assignment field 1306, and the resource assignment field 1308 can be used to indicate grants for multiple mobile stations. The mobile stations process the control header to determine if their assigned group position matches a position identifier 1304 listed in the control header. If so, the mobile station determines that it is granted the resource described by the interlace assignment 1306 and resource assignment 1308.

The overhead associated with granting resources as described above can be prohibitive under certain conditions. Therefore, in some embodiments, a hashing algorithm is used to reduce the number of bits required in the control header. In this embodiment, the control header 1302 contains M bits, where M is a positive integer greater than or equal to two, to control a hashing scheme which indicates that a particular resource has been granted in a known interlace, for example in the next interlace. In particular, each mobile station for which the base station has not acknowledged the current packet after a known number of transmissions will look at the N least significant bits of its assigned group position after truncating the number of least significant bits indicated in the M bit control header. These bits represent the granted resource. The base station determines the value of the control header such that the set of mobile stations for which the base station has not acknowledged their current packets are granted resources that do not overlap. The base station then sets the utilized resources field corresponding to the resources assigned according to the hashing scheme in the known interlace, for example the next interlace, to ‘1’.

As an illustrative example, consider that the control header has a length of four bits (M=4), the value of N is two bits, and the known interlace is the next interlace. Further, assume that the base station has determined that it has not acknowledged the current packet for the mobile stations with 8 bit position indices of ‘10100110’ and ‘011001010’. If the base station sets the four bit control header to ‘0000’, then the mobile stations will determine their granted resources as ‘10’ and ‘10’, respectively, since these are two least significant bits in each position index. Since these values are the same, the base station will choose a different value for the control header. For example, if the base station sets the four bit control header to ‘0001’, then the mobile stations will determine their granted resources as ‘11’ and ‘01’, respectively, since these are the least two least significant bits of each position index after truncating the ‘0001’=1 least significant bit.

Because these values are different, the base station may use this value of the control header to indicate that the mobile station with position ‘10100110’ is assigned the ‘11’ resource in the next interlace and that the mobile station with position ‘11001010’ is assigned the ‘01’ resource in the next interlace. The base station indicates to the mobile stations assigned to the next interlace that two of its resources are being utilized by setting the bits of the utilized resources field corresponding to resource ‘11’ and resource ‘01’ to ‘1’. This scheme takes advantage of the fact that there will only be a few mobile stations requiring resources after a certain number of transmissions, and, therefore there will only be a few mobile stations looking at the control header.

Turning now to FIG. 14, a mobile station 1401 and base station 1403 architectures in accordance with the various embodiments are illustrated. Mobile station 1401 comprises a stack having a VoIP application 1405, a networking layer 1407, a Radio Link Controller (RLC) 1409, a Medium Access Controller (MAC) 1411, and a Physical Layer (PHY) 1413. In addition, mobile station 1401 has HARQ component 1415, which may be separate or may be integrated into any of the other components/layers. As described in detail above, the mobile station 1401 HARQ component 1415 may receive a utilized resources field and/or a first HARQ transmission assignments field for determining its resource allocations for transmitting or receiving data. The mobile station may transmit request messages to the base station on the physical layer.

The base station 1403 similarly has a VoIP application 1417, a networking layer 1419, a RLC 1421, MAC 1423 and PHY 1427. However, base station 1403 additionally has in the various embodiments HARQ scheduling component 1425. As described in detail above, the base station 1403 HARQ scheduling component 1425 may send a reserved blocks field and/or a first HARQ transmission assignments field to groups and/or subgroups of mobile stations for indicating their resource allocations for transmitting or receiving data. Further, the HARQ scheduling component 1425 may define the HARQ subgroups in some embodiments.

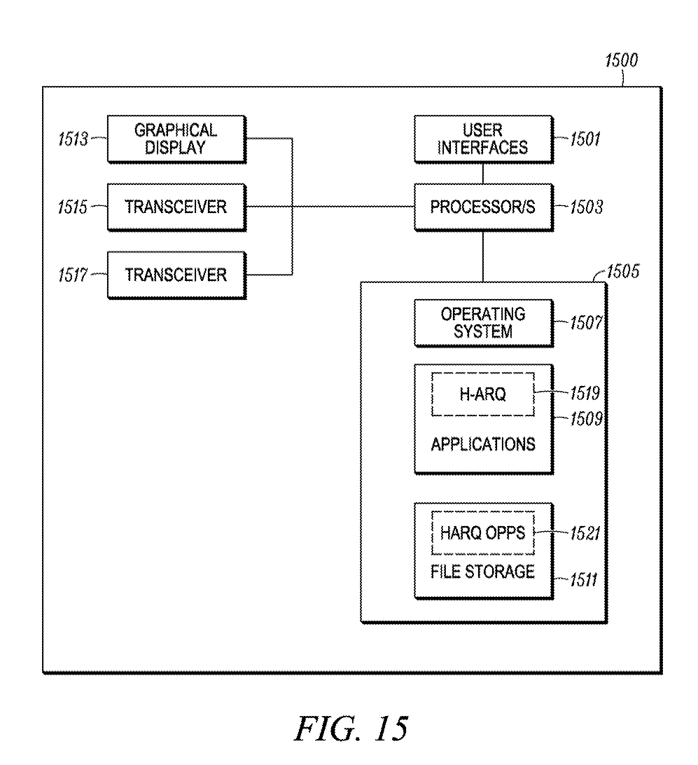

FIG. 15 is a block diagram illustrating the primary components of a mobile station in accordance with some embodiments. Mobile station 1500 comprises user interfaces 1501, at least one processor 1503, and at least one memory 1505. Memory 1505 has storage sufficient for the mobile station operating system 1507, applications 1509 and general file storage 1511. Mobile station 1500 user interfaces 1501, may be a combination of user interfaces including but not limited to a keypad, touch screen, voice activated command input, and gyroscopic cursor controls. Mobile station 1500 has a graphical display 1513, which may also have a dedicated processor and/or memory, drivers etc. which are not shown in FIG. 15.

It is to be understood that FIG. 15 is for illustrative purposes only and is for illustrating the main components of a mobile station in accordance with the present disclosure, and is not intended to be a complete schematic diagram of the various components and connections therebetween required for a mobile station. Therefore, a mobile station may comprise various other components not shown in FIG. 15 and still be within the scope of the present disclosure.

Returning to FIG. 15, the mobile station 1500 may also comprise a number of transceivers such as transceivers 1515 and 1519. Transceivers 1515 and 1517 may be for communicating with various wireless networks using various standards such as, but not limited to, UMTS, E-UMTS, E-HRPD, CDMA2000, 802.11, 802.16, etc.

Memory 1505 is for illustrative purposes only and may be configured in a variety of ways and still remain within the scope of the present disclosure. For example, memory 1505 may be comprised of several elements each coupled to the processor 1503. Further, separate processors and memory elements may be dedicated to specific tasks such as rendering graphical images upon a graphical display. In any case, the memory 1505 will have at least the functions of providing storage for an operating system 1507, applications 1509 and general file storage 1511 for mobile station 1500. In some embodiments, and as shown in FIG. 14, applications 1509 may comprise a software stack that communicates with a stack in the base station. Therefore, applications 1509 may comprise HARQ component 1519 for providing the capabilities of using the HARQ scheduling information received from a base station as was described in detail above. File storage 1511 may provide storage for an HARQ OPPS allocation, as illustrated by FIG. 15.

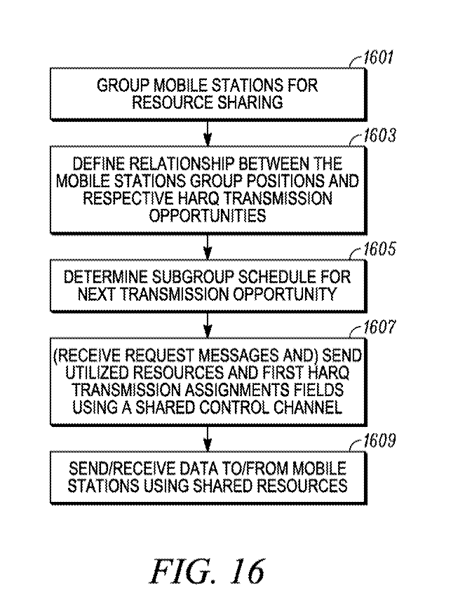

FIG. 16 summarizes operation of a base station in accordance with the various embodiments. In 1601, the base station groups mobile stations for scheduling resources based on various criteria as was discussed previously. In 1603, the base station defines the relationship between the mobile station's group positions and their respective HARQ transmission opportunities as was described with respect to FIG. 6. In 1605, the base station may further determine subgroups for the next transmission opportunity. In particular, at 1605, the base station may determine which subgroup is allocated a first HARQ transmission opportunity at the next transmission opportunity. In 1607, the base station sends a utilized resources and first HARQ transmission assignments field, which may be a bitmapping sent over a shared control channel as previously described. The base station may also receive request messages from mobile station in the group, in 1607. In 1609, the base station may send data to, or receive data from, the mobile stations using the set of shared resources.

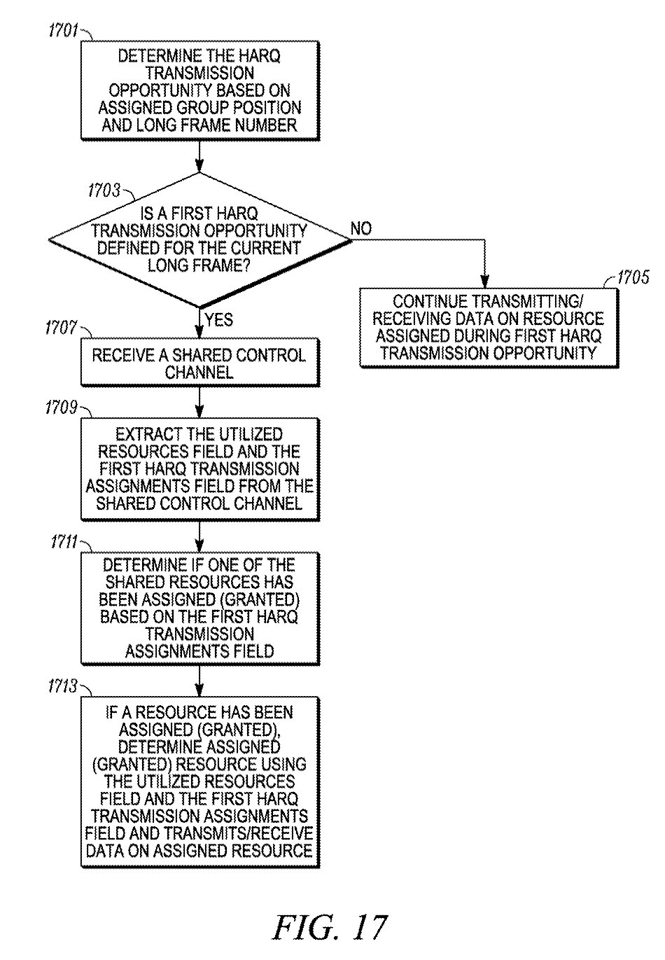

FIG. 17 is a flow chart showing operation of a mobile station 102 receiving the shared control channel. In 1701, the mobile station determines its HARQ transmission opportunity based on its assigned group position (i.e. assigned subgroup) and long frame number. In 1703, the mobile station determines if a first HARQ transmission opportunity is defined for the current long frame. If no, in 1705, the mobile station continues to transmit or receive data on the resource assigned during the first HARQ transmission opportunity of the packet, unless the packet has previously been acknowledged in which case the mobile station does nothing. If yes, in 1707, the mobile station receives a shared control channel. In 1709, the mobile stations extracts the utilized resources field and the first HARQ transmission assignments field from the shared control channel. In 1711, the mobile station determines if one the shared resources has been assigned, or granted in the case of a request, based on the first HARQ transmission assignments field. Finally, in 1713, if a resource has been assigned or granted, the mobile station determines the exact assigned or granted resource using the utilized resources field and the first HARQ transmission assignments field and transmits or receives data on assigned resource.

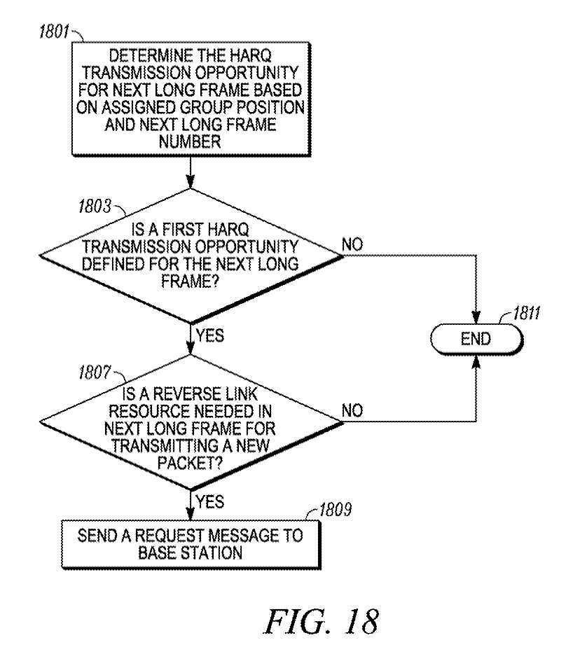

FIG. 18 is a flow chart showing operation of a mobile station 102 for transmitting request messages. In 1801, the mobile station determines its HARQ transmission opportunity based on its assigned group position (i.e. assigned subgroup) and its next long frame number. In 1803, the mobile station determines if a first HARQ transmission opportunity is defined for the next long frame for reverse link transmission. If no, in 1811, the flow chart ends. If yes, in 1807, the mobile station determines if it has a new packet to transmit in the next long frame. If yes, in 1809, the mobile stations sends a request message to the base station. In no, in 1811, the flow chart ends.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a network infrastructure entity, the method comprising:
sending, to a group of mobile stations, a first indicator for indicating resources in use from a set of shared resources; and
sending a second indicator for indicating which mobile stations of said group have a first transmission opportunity defined and are being allocated at least one resource of said set of shared resources.

2. The method of claim 1, wherein sending said first indicator further comprises sending a bitmap, wherein each position in the bitmap corresponds to one resource of said set of shared resources.

3. The method of claim 1, wherein sending said second indicator further comprises sending a bitmap, wherein each position in the bitmap corresponds to a mobile station for which said first transmission opportunity is defined.

4. The method of claim 1, further comprising sending a first transmission of an encoded packet to a mobile station indicated as active via said second indictor using a resource of said set of shared resources that is not indicated as in use via said first indicator.

5. The method of claim 4, further comprising sending a second transmission to said mobile station using said resource.

6. A method in a mobile station, the method comprising:
receiving a first indicator for indicating resources in use from a set of shared resources;
receiving a second indicator for indicating which mobile stations of said group have a first transmission opportunity defined and are being allocated at least one resource of said set of shared resources; and
determining if said mobile station is assigned at least one of said set of shared resources if a pending transmission opportunity for said mobile stations is a first transmission opportunity, using said first indicator and said second indicator.

7. A mobile station comprising:
at least one transceiver;
at least one processor coupled to said transceiver; said processor configured to:
receive a first indicator for indicating resources in use from a set of shared resources;
receive a second indicator for indicating which mobile stations of said group have a first transmission opportunity defined and are being allocated at least one resource of said set of shared resources; and
determine if said mobile station is assigned at least one of said set of shared resources if a pending transmission opportunity for said mobile stations is a first transmission opportunity, using said first indicator and said second indicator.

8. A base station comprising:
a transceiver;
a processor coupled to said transceiver, said processor configured to:
send, to a group of mobile stations, a first indicator for indicating resources in use from a set of shared resources; and
send a second indicator for indicating which mobile stations of said group have a first transmission opportunity defined and are being allocated at least one resource of said set of shared resources.

9. The base station of claim 8, wherein said processor is further configured to send said first indicator by sending a bitmap, wherein each position in the bitmap corresponds to one resource of said set of shared resources.

10. The base station of claim 8, wherein said processor is further configured to send said second indicator by sending a bitmap, wherein each position in the bitmap corresponds to a mobile station for which said first transmission opportunity is defined.

11. The base station of claim 8, wherein said processor is further configured to send a first transmission of an encoded packet to a mobile station indicated as active via said second indictor using a resource of said set of shared resources that is not indicated as in use via said first indicator.

12. The base station of claim 8, wherein said processor is further configured to send a second transmission to said mobile station using said resource.
